(19) United States
(12) Patent Application Publication
(10) Pub. No.: US 2026/0291433 A1
(43) Pub. Date: Sep. 24, 2026

(54) ROBOTIC THERMAL INSPECTION OF PHOTOVOLTAIC MODULES

(71) Applicant: Nextpower LLC, Fremont, CA (US)

(72) Inventors: Jitendra Morankar, San Ramon, CA (US); Akshay Keshav Roge, Malad (East) (IN); Daniel Shugar, Pacifica, CA (US)

(21) Appl. No.: 19/571,387

(22) Filed: Mar. 18, 2026

Related U.S. Application Data
(60) Provisional application No. 63/774,913, filed on Mar. 20, 2025.

(51) Int. Cl. H02S 50/15; A46B 13/00; A46B 13/04; A46B 15/00; G01B 11/06; G01J 1/42; G01N 25/72; G06T 7/00; H04N 23/23; H04N 23/90

(52) U.S. Cl. CPC H02S 50/15; A46B 13/001; A46B 13/04; A46B 15/0055; G01B 11/0616; G01J 1/42; G01N 25/72; G06T 7/0002; H04N 23/23; H04N 23/90; A46B 2200/3073; G01J 2001/4266; G06T 2207/10048; G06T 2207/30252

(57) ABSTRACT

A robotic thermal inspection system includes a robotic body and thermal analysis module. The robotic body includes a controller and a thermal imaging device coupled to the controller. The thermal analysis module is in communication with the thermal imaging device and includes a programmable processor that instructions to cause the programmable processor to: receive, from the thermal imaging device, thermal imaging data related to the photovoltaic module, compare the received thermal imaging data to at least one predetermined thermal threshold, and when the received thermal imaging data meets the at least one predetermined thermal threshold, provide a photovoltaic module defect indication.

### CROSS-REFERENCE TO RELATED APPLICATIONS

This application claims the benefit of U.S. Provisional Patent Application No. 63/774,913, filed Mar. 20, 2025, the entire contents of which is hereby incorporated by reference.

### TECHNICAL FIELD

This disclosure relates generally to thermal inspection devices, systems, and methods. Embodiments disclosed herein describe robotic thermal inspection of photovoltaic modules, including in some examples robotic thermal inspection in the context of a solar tracker system, though other embodiments can be applied to other solar power component systems.

### BACKGROUND

Photovoltaic (PV) systems are an essential part of renewable energy infrastructure, converting sunlight into electricity to meet growing energy demands sustainably. PV systems, commonly installed as ground-mounted solar farms or rooftop arrays, rely on exposure of photovoltaic cells at one or more photovoltaic modules (“solar modules”) to sunlight to convert this irradiated sunlight into electrical energy. However, if one or more photovoltaic modules have certain defects, power generation capability can be degraded or become nonfunctional.

Given the number of photovoltaic modules utilized at utility-scale solar farms (e.g., solar tracker systems), manual inspection of individual photovoltaic modules can be labor-intensive and time-consuming. Thus, this can make the cost of routinely, manually inspecting photovoltaic modules impractical. Yet, without routinely inspecting the photovoltaic modules for defects that hamper energy generation capability, the efficiency and function of a solar system can be degraded.

### SUMMARY

Thermography can be a useful diagnostic tool for inspecting photovoltaic (“PV”) modules by enabling the detection of thermal anomalies that can indicate one or more potential defects at the PV module. The present disclosure describes exemplary embodiments of thermal inspection devices, systems, and methods. In particular, this disclosure describes exemplary applications of such thermal inspection embodiments to thermal inspection of at least one or more PV modules, for instance, to identify and/or predict one or more PV module potential defects. Examples disclosed herein include thermal inspection devices, systems, and methods for thermally inspecting PV modules at a solar tracker. Such devices, systems, and methods for thermally inspecting PV modules as disclosed herein can be autonomous or semi-autonomous. By integrating thermal inspection at a robotic vehicle movable relative to PV modules, embodiments disclosed herein can enable real-time performance insights (e.g., real-time PV module performance insights), defect identification (e.g., categorizing a PV module defect), and/or assessment of a preceding maintenance task at the PV module (e.g., assessment of at least one of: a sweeping performance in removing particulate from the surface of the PV module, a coating application at the PV module (e.g.. assessing a uniformity of a thickness of an applied coating layer at the surface of the PV module), and/or a fluid cleaning solution application at the PV module).

PV thermal inspection embodiments disclosed herein can be particularly advantageous for utility-scale solar trackers. By partially or fully automating PV module inspection and/or maintenance tasks, embodiments disclosed herein can reduce operational costs, increase energy yields, and extend the lifespan of solar panels. For example, embodiments disclosed herein can identify defects by identifying one or more hot spots, string disconnection, mechanical cracking, and/or delamination at the PV module leading to power loss at the PV module. As another example, embodiments disclosed herein can monitor performance of PV modules using thermal mapping/profiling to assess PV module efficiency and identify any relative power generation underperforming region at the PV module.

For instance, certain embodiments disclosed herein include thermally inspecting photovoltaic modules using a thermal imaging device at a robotic body that is movable relative to (e.g., along) a row of photovoltaic modules. For instance, the robotic body can be configured to traverse in a first direction at a first time over surfaces of photovoltaic modules along a row of a solar tracker to capture first thermal data relating to the photovoltaic modules along the row of a solar tracker, and then the robotic body can be configured to traverse in a second, opposite direction at a second, later time over surfaces of photovoltaic modules along the row to capture second thermal data relating to the photovoltaic modules along the row of the solar tracker.

In some embodiments, the devices, systems, and methods can be further configured to, in addition to thermal inspection of PV modules, execute one or more maintenance operations at one or more PV modules (e.g., when traversing the row). For instance, these devices, systems, and methods disclosed herein can be configured to execute a maintenance operation at one or more PV modules by at least sweeping a surface of one or more PV modules, applying a coating material to a surface of one or more PV modules, and/or applying a fluid cleaning solution (e.g., pressurized air, liquid cleaning solution, such as water and/or detergent, and/or an atomized mixture of liquid cleaning solution and pressurized air) to a surface of the one or more PV modules. By executing such a maintenance operation at one or more PV modules in conjunction with thermally inspecting such one or more PV modules, embodiments disclosed herein can enable more accurate thermal inspection by reducing the impact of particulate on the surface of the PV module when thermally inspecting that surface of the PV module. This can also allow embodiments disclosed herein to evaluate the effectiveness of the maintenance operation (e.g., whether a suitable coating thickness has been applied; whether the applied fluid cleaning solution sufficiently removed particulate, etc.). Thus, embodiments disclosed herein can use advanced mechanisms, such as soft brushes, air blowers, or dry cleaning techniques, to remove debris efficiently and sustainably. And, for instance, embodiments disclosed herein (e.g., robotic body) can be equipped with smart sensors, machine learning algorithms, and/or remote monitoring capabilities, and thereby can provide a reliable, efficient, and cost-effective solution for maintaining PV system performance.

One embodiment includes a robotic thermal inspection system. This system includes a robotic body and a thermal analysis module. The robotic body includes a controller, a motive source coupled to the controller, a thermal imaging device coupled to the controller, and an attachment mechanism for attaching the robotic body to a photovoltaic module. The thermal analysis module is in communication with the thermal imaging device. The thermal analysis module includes a programmable processor and a non-transitory computer-readable medium storing instructions that, when executed by the programmable processor, cause the programmable processor to: receive, from the thermal imaging device, thermal imaging data related to the photovoltaic module, compare the received thermal imaging data to at least one predetermined thermal threshold, and when the received thermal imaging data meets the at least one predetermined thermal threshold, provide a photovoltaic module defect indication.

In a further embodiment of this system, the thermal analysis module is at a server remote from the robotic body, and the thermal imaging device is in wireless data communication with the thermal analysis module.

In a further embodiment of this system, the thermal analysis module is onboard the robotic body.

In a further embodiment of this system, when executed by the programmable processor, the instructions further cause the programmable processor to: calibrate the thermal imaging device based on at least one environmental condition ambient to the thermal imaging device. For example, when executed by the programmable processor, the instructions can further cause the programmable processor to: determine a presence of solar light irradiance at the photovoltaic module exceeding a predetermined irradiance threshold, and when the presence of solar light irradiance at the photovoltaic module is determined to exceed a solar light irradiance threshold, adjust an orientation of the thermal imaging device, relative to the robotic body, to reduce solar light irradiance captured by the thermal imaging device. As another example, when executed by the programmable processor, the instructions can further cause the programmable processor to: determine a presence of wind at the robotic body exceeding a predetermined wind threshold, and when the presence of wind at the robotic body is determined to exceed the predetermined wind threshold, terminate thermal imaging at the thermal imaging device.

In a further embodiment of this system, the robotic body further comprises a brush assembly coupled to the controller. For example, the thermal imaging device can be disposed at the robotic body to capture thermal imaging data at the photovoltaic module after the brush assembly has passed over the photovoltaic module. In some such embodiments, the robotic body can further include a coating applicator coupled to the controller, and the robotic body can be configured to apply a coating material, via the coating applicator, to the photovoltaic module. For instance, when executed by the programmable processor, the instructions can further cause the programmable processor to: after the robotic body has applied the coating material to the photovoltaic module, use the received thermal imaging data to evaluate a coating layer thickness, associated with the applied coating material, by comparing the received thermal imaging data to at least one predetermined threshold, and, when the received thermal imaging data falls outside of the at least one predetermined threshold, provide a coating layer thickness defect indication. In one such example, the coating material can include a hydrophobic coating that is configured to reduce particulate accumulation at the photovoltaic module.

In a further embodiment of this system, the photovoltaic module defect indication can include an indication relating to at least one of: an electrical component failure at the photovoltaic module, a string disconnection at the photovoltaic module, and a mechanical defect at a surface of the photovoltaic module.

In a further embodiment of this system, the thermal imaging data can be first thermal imaging data captured by the thermal imaging device when the robotic body traverses over the photovoltaic module at a first time. And, when executed by the programmable processor, the instructions can further cause the programmable processor to: receive, from the thermal imaging device, second thermal imaging data related to the photovoltaic module when the robotic body traverses over the photovoltaic module at a second, different time, compare the received second thermal imaging data to at least the first thermal imaging data, and, when the received second thermal imaging data differs from the first thermal imaging data, provide the photovoltaic module defect indication. In one such example, when executed by the programmable processor, the instructions can further cause the programmable processor to: output a prediction as to future photovoltaic module failure when the received second thermal imaging data differs from the first thermal imaging data, or other predefined reference thermal data, beyond a predetermined extent.

In a further embodiment of this system, the thermal imaging device includes a first thermal imaging camera and a second thermal imaging camera spaced apart about the robotic body. For example, the first thermal imaging camera can be disposed at the robotic body to capture first thermal imaging data at a first region along the photovoltaic module, and the second thermal imaging camera can be disposed at the robotic body to capture second thermal imaging data at a second, different region along the photovoltaic module. And the thermal analysis module can be configured to combine the first thermal imaging data with the second thermal imaging data to form a composite thermal imaging data map of the first region along the photovoltaic module and the second region along the photovoltaic module.

Another embodiment include a method of thermally inspecting a photovoltaic module. This method embodiment includes the steps of: moving a robotic body, along a photovoltaic module, to capture thermal imaging data relating to the photovoltaic module using a thermal imaging device at the robotic body; comparing the captured thermal imaging data to at least one predetermined thermal threshold, and, when the captured thermal imaging data meets the at least one predetermined thermal threshold, providing a photovoltaic module defect indication.

In a further embodiment of this method, the method further includes the steps of: determining at least one of: (i) solar light irradiance at the photovoltaic module either exceeding or falling below a predetermined irradiance threshold, and (ii) wind speed at the robotic body exceeding a predetermined wind threshold; when the solar light irradiance at the photovoltaic module is determined to exceed the predetermined irradiance threshold, adjusting an orientation of the thermal imaging device, relative to the robotic body, to reduce solar light irradiance captured by the thermal imaging device; and when wind speed at the robotic body is determined to exceed the predetermined wind threshold, terminating thermal imaging at the thermal imaging device.

In a further embodiment of this method, the method further includes the steps of: sweeping a surface of the photovoltaic module using a brush assembly at the robotic body while moving the robotic body along the photovoltaic module; and after sweeping the surface of the photovoltaic module using the brush assembly, capturing the thermal imaging data relating to the photovoltaic module using the thermal imaging device.

In a further embodiment of this method, the method further includes the step of: attaching the robotic body to the photovoltaic module such that one or more wheels at the robotic body contact the photovoltaic module.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings.

FIG. 1 is a perspective view of an embodiment of a solar tracker system.

FIG. 2 is a schematic, top view of a solar tracking system arranged in rows of continuous trackers spaced apart from one another, with a robotic thermal inspection system thermally inspecting PV modules along a row of the solar tracking system.

FIGS. 3A and 3B illustrate an embodiment of a robotic body that can be part of a robotic thermal inspection system, such as that of FIG. 2. FIG. 3A is a block diagram of this embodiment of the robotic body, and FIG. 3B is a perspective view of this embodiment of the robotic body at a PV module.

FIGS. 4A and 4B illustrate another embodiment of a robotic body that can be part of a robotic thermal inspection system, such as that of FIG. 2. FIG. 4A is a block diagram of this embodiment of the robotic body, and FIG. 4B is a perspective view of this embodiment of the robotic body at a PV module.

FIGS. 5A and 5B show exemplary representations of a composite thermal imaging data map of a surface of a PV module at different times.

FIG. 6 is a flow diagram of an embodiment of method of thermally inspecting a PV module.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to thermal inspection of one or more PV modules. Such embodiments can be configured to execute a thermal inspection of one or more PV modules (e.g., a thermal inspection of a surface of one or more PV modules facing the sun) to identify and/or predict one or more potential defects at the PV module. For example, embodiments disclosed herein can capture thermal imaging data relating to one or more PV modules, compare this thermal imaging data to a predetermined thermal threshold, and when the thermal imaging data meets the predetermined threshold, a PV module defect indication can be provided. Capturing and analyzing thermal imaging data relating to one or more PV modules, for instance as a robotic body carrying a thermal imaging device traverses along a row of PV modules, can be useful in identifying and/or predicting PV module defects, such as hotspots, electrical string issue(s), PV module performance irregularities. Additionally or alternatively, capturing and analyzing thermal imaging data relating to one or more PV modules, for instance as a robotic body carrying a thermal imaging device traverses along a row of PV modules, can be useful in evaluating an efficacy of a maintenance operation (e.g.,. sweeping application, coating application, and/or fluid cleaning solution application) performed at the PV module(s).

In examples where the robotic body is configured to perform one or more maintenance operations in addition to capturing PV module thermal imaging data, the robotic body can include a brush assembly and/or a maintenance solution applicator. For instance, some such exemplary embodiments include robotic thermal inspection devices, systems, and methods that can perform a PV module maintenance (e.g., cleaning) function by at least applying a brush, coating, and/or a fluid cleaning solution (e.g., pressurized air and/or liquid cleaning solution, such as detergent) to the PV module. For example, certain such embodiments disclosed herein include robotic thermal imaging devices, systems, and methods that perform a PV module maintenance task by cleaning (e.g., sweeping, blowing, wiping, etc.) a PV module and applying a maintenance solution, such as a coating material and/or fluid cleaning solution, to the PV module (e.g., applying the coating to the PV module after the PV module has been swept). When used, the coating applied to the PV module by the robotic body can be configured to reduce particulate accumulation at the PV module where the coating is applied (e.g., the coating can be a hydrophobic coating that acts to reduce dust/dirt particulate accumulation at the PV module). As such, once the PV module has had such a coating applied on it via the robotic body, future resources associated with cleaning of that PV module may be reduced.

In this way, certain such examples disclosed herein can increase the efficiency associated with PV module maintenance at a solar tracking system by both capturing PV module thermal imaging data to help detect and/or predict one or more PV module defects and performing one or more maintenance operations at the one or more PV modules where thermal imaging data is captured. Accordingly, such embodiments can not only help to reduce future instances of suboptimal energy production, but do so in a way that synergistically accomplishes these functions while the robotic body traverses along a row of PV modules.

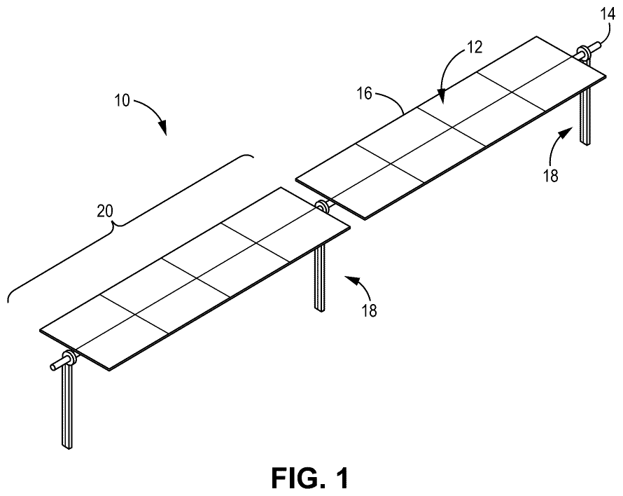

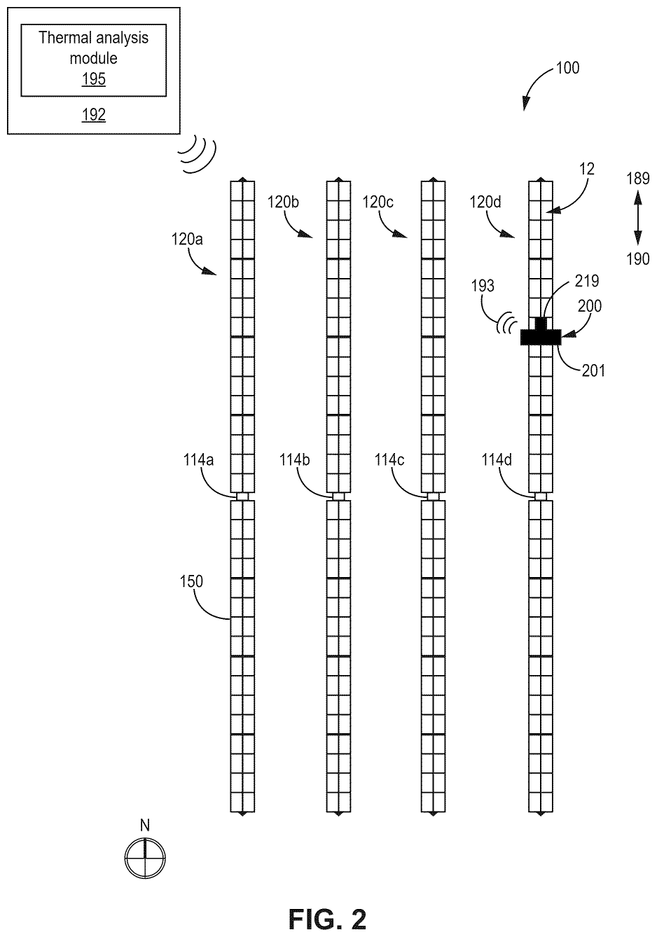

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array, such as illustrated at FIG. 2. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more PV modules (or “solar modules”) 12 mounted to the torque tube 14 such that the PV modules 12 can be oriented to a desired position. That desired position may be to a position to maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the PV modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the PV modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the PV modules 12 relative to the sun, while supporting the PV modules 12 on the bracket system. The bracket system may take many forms including two pieces of shaped steel, which may be arranged to sandwich the PV modules 12, and may be configured to connect to a rail, which is then coupled to the torque tube 14.

Each PV module 12 of the solar tracker 10 can include one or more PV cells that is configured to convert sunlight into electrical energy. Each PV module can have a plurality of PV cells disposed along on a laminate substrate, and the laminate substrate can be at least partially bounded by a frame. Thus, as sunlight irradiates onto the PV cells, the PV module can generate electrical energy. However, when particulate has accumulated onto the PV module, it can obstruct this electrical generation function of the PV module. Accordingly, the function of applying a coating that can reduce particulate accumulation at the PV module (e.g., reduce particulate accumulation over the PV cells) can be useful in reducing or preventing future degradation of the electrical generation function of the PV module.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

As noted, PV robotic thermal inspection system 200 and method embodiments described herein can perform at least a PV module thermal inspection function by capturing thermal imaging data related to one or more PV modules 12. FIG. 2 shows a schematic illustration of a PV robotic thermal inspection system 200 performing a PV module thermal inspection function by capturing thermal imaging data related to (e.g., at) one or more PV modules 12. To execute such a function, the system 200 can include a thermal imaging device 219. As shown here, the thermal imaging device 219 can be carried at the robotic body 201, and the PV robotic thermal inspection system 200 (e.g., robotic body 201) can move relative to PV modules 12, for instance relative to a given row 120d, so as to traverse PV modules 12 of the given row 120d, such as in directions 189, 190. The direction 189 can be a north or south direction and the direction 190 can be the other of north and south such that the PV robotic thermal inspection system 200 moves along the given row 120d in the north and/or south directions, though other applications can include robotic system 200 movement in additional or alternative direction(s). For certain embodiments, the PV robotic thermal inspection system 200 can be configured to move bi-directionally along the given row 120d such that the PV robotic thermal inspection system 200 can be configured to move in both a north and a south direction along the given row 120d. As the PV robotic thermal inspection system 200 is moved relative to a given PV module 12, the PV robotic thermal inspection system 200 can capture thermal data, via the thermal imaging device 219, related to the PV modules 12 as robotic body 201 moves along the tow 120d. For instance, at shown at FIG. 2, when the PV robotic thermal inspection system 200 is moved along one or more PV modules 12 in the direction 190, the PV robotic thermal inspection system 200 can capture thermal data (e.g., thermal imaging data) along the row 120d in the direction 190.

For some embodiments, the thermal imaging device 219 can be carried at the robotic body 201 such that the thermal imaging device 219 can be selectively removed from the robotic body 201. Thus, the thermal imaging device 219 could be a module hardware device that can be removably attached at the robotic body 201 when one or more thermal inspection applications are to be carried out.

This captured thermal data relating to one or more PV modules 12 can be used to detect and/or predict one or more PV module defects. For instance, the captured thermal data relating to PV modules 12 can be used to identify and/or predicting PV module defects, such as hotspots, electrical string issue(s), PV module performance irregularities. As one example, the captured thermal data relating to PV modules 12 can be compared to one or more predetermined thermal thresholds, and, when this captured thermal data meets the one or more predetermined thermal thresholds, a PV module defect indication can be provided (e.g., by indicating a present PV module defect and/or by indicating a potential future PV module defect).

As shown in FIG. 2, the PV robotic thermal inspection system 200 can be configured for communication with a remote server 192. In the illustrated example, the PV robotic thermal inspection system 200 is in wireless communication 193 with the remote server 192. For example, the PV robotic thermal inspection system 200, such as at robotic body 201, can include one or more remotely monitored components in data communication with the remote server 192. Accordingly, as the PV robotic thermal inspection system 200 is operated to acquire thermal data at one or more PV modules 12, this thermal data from the PV robotic thermal inspection system 200 can be communicated to the remote server 192. This can, for example, facilitate remote monitoring (e.g., real-time) and/or control of the PV robotic thermal inspection system 200 via the remote server 192. In addition, in some cases, the PV robotic thermal inspection system 200 can be in bi-directional communication with the remote server 192 such that the remote server 192 can transmit instructions or other data to the PV robotic thermal inspection system 200, for instance, to actuate a control function at the PV robotic thermal inspection system 200. In some embodiments, the PV robotic thermal inspection system 200 can integrate with Supervisory Control and Data Acquisition (SCADA) system(s) to enable remote monitoring and control of the PV robotic thermal inspection system 200. For example, the PV robotic thermal inspection system 200 can be remotely monitored and controlled as to thermal data capture, coating application, and/or cleaning fluid (e.g., water and/or a cleaning solution and/or pressurized air) application metrics.

As noted, the PV robotic thermal inspection system 200 can capture thermal data relating to one or more PV modules 12, and this captured thermal data relating to PV modules 12 can be used to identify and/or predicting PV module defects, such as hotspots, electrical string issue(s), PV module performance irregularities. As one example, the captured thermal data relating to PV modules 12 can be compared to one or more predetermined thermal thresholds, and, when this captured thermal data meets the one or more predetermined thermal thresholds, a PV module defect indication can be provided (e.g., by indicating a present PV module defect and/or by indicating a potential future PV module defect).

A thermal analysis module 195 can be included at the robotic thermal inspection system 200 to execute one or more PV module thermal inspections. The thermal analysis module 195 can include one or more programmable processors and one or more associated non-transitory computer readable mediums storing instructions that, when executed by the programmable processor, can cause the programmable processor of the thermal analysis module 195 to: receive the captured PV module thermal imaging data relating to PV modules 12, compare this thermal data to one or more predetermined thermal thresholds, and, when this captured thermal data meets the one or more predetermined thermal thresholds, provide a PV module defect indication can be provided (e.g., by indicating a present PV module defect and/or by indicating a potential future PV module defect). As one example, the provided photovoltaic module defect indication can include an indication relating to at least one of: an electrical component failure at one or more PV modules corresponding to the captured thermal data, a string issue (e.g., electrical disconnection) at one or more PV modules corresponding to the captured thermal data, and a mechanical defect at a surface of one or more PV modules corresponding to the captured thermal data. For instance, the provided photovoltaic module defect indication can identify and/or predict one or more hot spots at a PV module 12, mechanical cracking at a PV module 12, and/or delamination at a PV module 12 leading to power loss at the PV module 12. In some embodiments, the thermal analysis module 195 can store a machine learning model that is configured, when executed, to derive thermal data patterns over time from the captured thermal imaging data relating to the PV module.

FIG. 2 shows an example where the thermal analysis module 195 is at the remote server 192, and thus remote from the robotic body 201, such that the thermal analysis module 195 can be in data communication (e.g., wireless data communication) with the robotic body 201. Though other examples can include the thermal analysis module 195 onboard the robotic body 201.

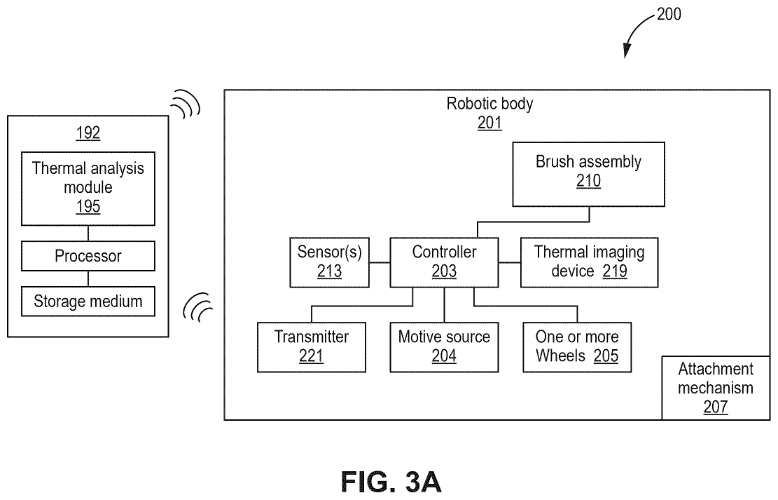

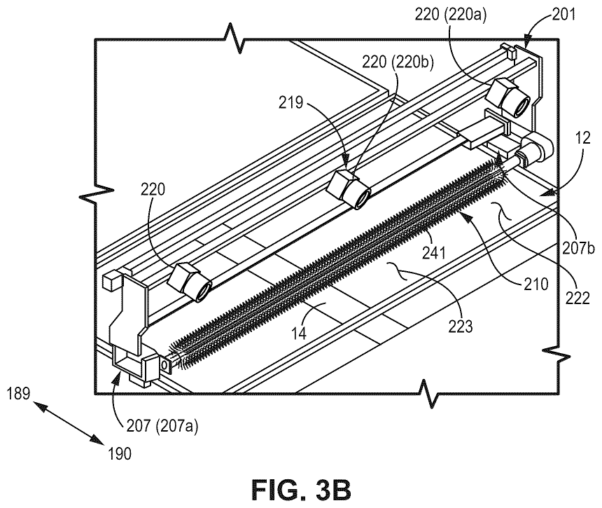

FIGS. 3A and 3B illustrate an embodiment of robotic body 201 of robotic thermal inspection system 200. FIG. 3A is a block diagram of this embodiment of the robotic body 201, and FIG. 3B is a perspective view of this embodiment of the robotic body 201 at a PV module 12 (e.g., at a row of PV modules 12, sch as row 120d). The robotic thermal inspection system 200 can be used to perform one or more inspection and/or maintenance operations at a solar tracker, as discussed herein. Though other embodiments within the scope of this disclosure can include applications of the robotic thermal inspection system 200 at static solar power generation structures as well.

In addition to the robotic thermal inspection system 200 including the thermal analysis module 195, the system 200 can include the robotic body 201. The embodiment of the robotic body 201 shown at FIGS. 3A and 3B can include at least a controller 203, a motive source 204 coupled to the controller 203, one or more wheels 205 coupled to the motive source 204, and thermal imaging device 219 coupled to the controller 203. This the robotic body 201 example shown at FIGS. 3A and 3B also includes at least one brush assembly 210. The brush assembly 210 can be coupled to the controller 203 such that the controller can actuate the brush assembly 210 to cause a brush member 241 to rotate relative to the robotic body 210, for instance, to perform a maintenance task at one or more PV modules 12. For instance, the controller can actuate the brush assembly 210 to cause a brush member 241 to rotate relative to the robotic body 210 to sweep a surface of one or more PV modules 12 and/or to finish a coating at a surface of one or more PV modules 12.

FIG. 3B shows an example arrangement of components at robotic body 201. As shown at this example, the thermal imaging device 219 can include one or more thermal imaging cameras 220. More specifically, FIG. 3B shows an example where the thermal imaging device 219 includes a first thermal imaging camera 220a and a second thermal imaging camera 220b spaced apart about the robotic body 201. The first thermal imaging camera 220a can be disposed at the robotic body 201 to capture first thermal imaging data at a first region 222 along the PV module 12, and the second thermal imaging camera 220b can be disposed at the robotic body 201 to capture second thermal imaging data at a second, different region 223 along the PV module 12. In this way, the thermal imaging device 219 carried at the robotic body 201 can be configured to capture thermal data at different regions about a given one or more PV modules 12. This captured thermal data relating to different regions 222, 223 about one or more PV modules 12 (e.g. about a common PV module 12) can be used by thermal analysis module 192 to compare to one or more predetermined thermal thresholds and, when such threshold is met, provide one or more PV module defect indications, such as one or more PV module defect indications corresponding to one or both of the discrete regions 222, 223 at PV module 12. As one example, thermal analysis module 192 can be configured to combine the first thermal imaging data (e.g., relating to PV module 12 region 222) with the second thermal imaging data (e.g., relating to PV module 12 region 223) to form a composite thermal imaging data map of the first region 222 along the PV module 12 and the second region 223 along the PV module 12.

FIG. 3B also shows an example where the robotic body includes brush assembly 210 having brush member 241. As illustrated here, the thermal imaging device 219 can be disposed at the robotic body 201 to capture thermal imaging data at one or more PV modules 12 after the brush assembly 210 has passed over the PV module 12. For instance, the robotic body 201 can traverse over PV module 12 in direction 189 such that the thermal imaging device 219 captures at least some thermal imaging data relating to PV module 12 after the brush assembly 210 has passed over PV module 12. This could include the controller 203 causing the thermal imaging device 219 to capture at least some thermal imaging data relating to PV module 12 at each of regions 222 and 223 after the brush member 241 has swept each of regions 222 and 223 at PV module 12. Using the brush assembly 210 to first perform a maintenance operation (e.g., sweeping) at the PV module 12, prior to capturing thermal data relating to that PV module 12, can be helpful in increasing the accuracy of the captured thermal data relating to the PV module. For instance, the brush assembly 210 can be actuated by the controller 203 to sweep off particulate (e.g., dirt, dust, etc.) from the PV module 12 before capturing thermal data relating to the PV module 12 which will be used in assessing (e.g., predicting) PV module 12 defects. This can help to acquire more thermally accurate data corresponding to the PV module 12 without potential noise/interference in the thermal data caused by the presence of particulate over PV cells at the PV module 12.

The illustrated embodiment of the robotic body 201 at FIGS. 3A and 3B can also include an attachment mechanism 207. The attachment mechanism 207 can be configured to movably attach the robotic body 201, directly or indirectly, to one or more solar tracker components, such as to one or more PV modules 12, such as one or more PV modules 12 along the row 120d. The attachment mechanism 207 can attach the robotic body 201, directly or indirectly, to one or more PV modules 12 such that the robotic body 201 can move along the one or more PV modules 12 (e.g., move along the row 120d via relative movement between the attachment mechanism 207 and the PV modules 12 of the row 120d). The example here shows the attachment mechanism 207 movably coupling the robotic body 201 to a frame portion of PV module 12 such that the robotic body 201 can move along frame portions of PV modules 12 to execute one or more thermal data acquisition and/or maintenance operations at the PV modules 12 as the robotic body 201 moves there along. The attachment mechanism 207 can include a first attachment mechanism 207a at a first side of the robotic body 201 configured to attach directly to a first end portion of the PV module 12 and a second attachment mechanism 207b at a second, opposite side of the robotic body 201 configured to attach directly to a second, opposite end portion of the PV module 12. As illustrated here, the maintenance solution applicator 206 can include a plurality of nozzles 216. As shown for this example, the plurality of nozzles 216 can be spaced apart from one another about the robotic body 201. For instance, the plurality of nozzles 216 can be spaced apart and aligned along an axis that extends transverse to the longitudinal axis of the robotic body 201 (e.g., and transverse to the direction of travel 189, 190 of the robotic body 201). The plurality of nozzles 216 can have an outlet cross-sectional geometry that is different when the plurality of nozzles 216 are included for applying a coating material versus when included for applying a fluid cleaning solution. For instance, the outlet cross-sectional area of the plurality of nozzles 216 can be smaller for coating applications than for fluid cleaning solution applications. The plurality of nozzles 216 of the applicator 206 can be disposed at the robotic body 201 between the first attachment mechanism 207a and the second attachment mechanism 207b.

In addition, some embodiments of the robotic body 201, such as that illustrated at FIGS. 3A and 3B, can include one or more sensors 213 coupled to controller 203. The one or more sensors 213 can be configured to detect one or more measurable operating characteristics related to the robotic body 201 and/or a maintenance operation being performed by the robotic body 201. For example, the robotic body 201 can include a wind speed sensor that is configured to detect wind speed ambient to the robotic body 201, and the controller 203 can be configured to adjust thermal data acquisition and/or maintenance operation being performed by the robotic body 201 when the detected wind speed exceeds a predetermined threshold. As another additional or alternative example, the robotic body 201 can include a light sensor (e.g., visible light sensor) that is configured to detect solar light irradiance at PV module 12, and the controller 203 can be configured to adjust thermal data acquisition and/or maintenance operation being performed by the robotic body 201 when the detected solar light irradiance exceeds a predetermined threshold.

The robotic thermal inspection system 200 can use the one or more sensors 213 for one or more calibrations. In such examples, the system 200 can use feedback from one or more sensors 213 to calibrate the thermal imaging device 219. For instance, this can enable the system 200 to calibrate the thermal imaging device 219 based on at least one environmental condition ambient to the thermal imaging device 219 (e.g., and ambient to the PV module 12).

As one such example, when executed by the programmable processor, computer readable instructions (e.g., of thermal analysis module 195) can cause the programmable processor to: calibrate the thermal imaging device 219 based on at least one environmental condition ambient to the thermal imaging device by at least causing the programmable processor to: determine a presence of solar light irradiance at the PV module 12 exceeding a predetermined irradiance threshold, and, when the presence of solar light irradiance at the PV module 12 is determined to exceed a solar light irradiance threshold, an orientation of the thermal imaging device 219 can be adjusted, relative to the robotic body 201, to reduce solar light irradiance captured by the thermal imaging device 219. As one such example, when the presence of solar light irradiance at the PV module 12 is determined to exceed a solar light irradiance threshold, the thermal imaging device 219 can be moved (e.g., rotated, pivoted, etc.), relative to the robotic body 201, to change an angular orientation of the thermal imaging device with respect to the robotic body in a way that acts to reduce solar light irradiance that is captured by the thermal imaging device 219. This can help to increase the accuracy of the captured thermal data relating to the PV module 12 as it can help to reduce noise/interference in the captured thermal data caused by solar light irradiating off of the surface of the PV module 12.

As another additional or alternative example, when executed by the programmable processor, computer readable instructions (e.g., of thermal analysis module 195) can cause the programmable processor to: calibrate the thermal imaging device 219 based on at least one environmental condition ambient to the thermal imaging device by at least causing the programmable processor to: determine a presence of wind at the robotic body 201 exceeding a predetermined wind threshold, and, when the presence of wind at the robotic body 201 is determined to exceed the predetermined wind threshold, terminate thermal imaging at the thermal imaging device 219. This can help to increase the accuracy of the captured thermal data relating to the PV module 12 as it can help to reduce noise/interference in the captured thermal data caused by wind gusts ambient to or at the surface of the PV module 12.

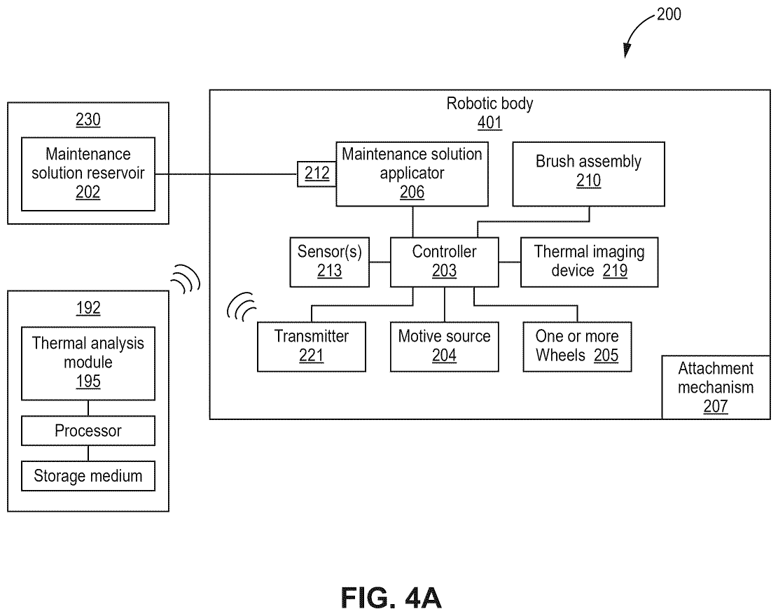

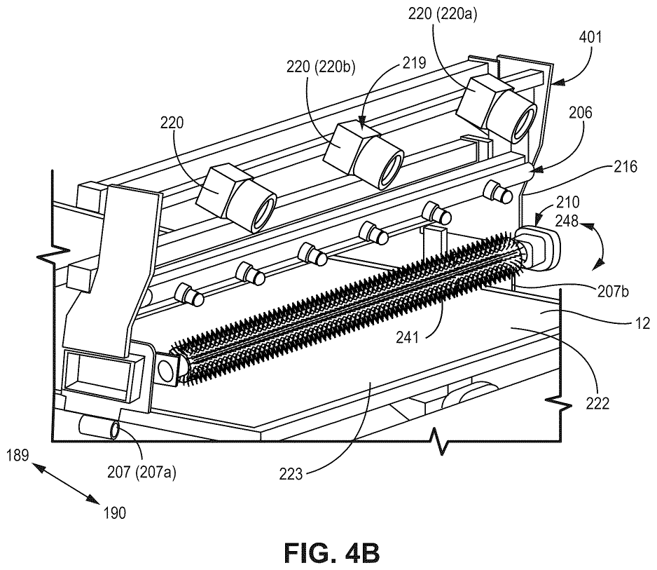

FIGS. 4A and 4B illustrate another embodiment of a robotic body 401 that can be part of the robotic thermal inspection system 200, such as that of FIG. 2. FIG. 4A is a block diagram of this embodiment of the robotic body 401, and FIG. 4B is a perspective view of this embodiment of the robotic body 401 at a PV module 12.

The illustrated embodiment includes a maintenance solution applicator 206, and the maintenance solution applicator 206 is coupled to the controller 203. The controller 203 can be configured to cause the motive source to apply a motive force to the one or more wheels 205 to cause the robotic body 401 to move relative to one or more PV modules 12. And, the controller 203 can be configured to actuate the maintenance solution applicator 206 to cause one or more maintenance solutions (e.g., a coating material and/or a fluid cleaning solution) to be output onto the one or more PV modules 12. For example, the controller 203 can be configured to move the robotic body 401 along one or more PV modules 12 (e.g., along row 120d) and to output one or more maintenance solutions from the maintenance solution applicator 206 at an output rate corresponding to the speed at which the controller 203 moves the robotic body 401 along one or more PV modules 12. This can be helpful in outputting a desired about of maintenance solution at a given area (e.g., 222 and/or 223) at one or more PV modules 12. In one example, the maintenance solution applicator 206 at robotic body 401 can include a coating applicator that is configured to output a coating material onto a surface of PV module 12. In another example, the maintenance solution applicator 206 at robotic body 401 can include a fluid cleaning solution applicator that is configured to output a fluid cleaning solution (e.g., pressurized air and/or liquid detergent solution, such as atomized liquid detergent solution) onto a surface of PV module 12. In yet another example, the maintenance solution applicator 206 at robotic body 401 can include both a coating applicator and a fluid cleaning solution applicator.

In addition to the robotic body 401, the system 200 can also include one or more maintenance solution reservoirs 202, such as a coating material reservoir and/or fluid cleaning solution reservoir. The one or more reservoirs 202 can be configured to supply one or more maintenance solutions, such as one or more coating materials and/or one or more cleaning solutions, respectively, to the maintenance solution application 206 (e.g., the coating applicator and/or the cleaning solution applicator, respectively). In some examples, the one or more reservoirs 202 can be carried at the robotic body 401. But in other examples, such as shown at FIG. 4A, the one or more reservoirs 202 can be in fluid communication with the maintenance solution applicator 206 but offboard, and thus remote from, the robotic body 401. In such examples where the one or more reservoirs 202 are offboard the robotic body 401, the one or more reservoirs 202 can be carried at a mobile cart 230 that is movable (e.g., with the robotic body 401), with the one or more reservoirs 202 in fluid communication between the mobile cart 230 and the maintenance solution applicator 206. Thus, the offboard reservoir 202 can be disposed on mobile cart 230 accompanying the robotic body 401.

Whether onboard or offboard the robotic body 401, the reservoir 202 can be in fluid communication with the maintenance solution applicator 206 at the robotic body 401. The reservoir 202 can be in fluid communication with the applicator 206 to thereby supply one or more mediums from the reservoir 202 to the applicator 206.

For example, the controller 203 can be configured to execute instructions to cause the controller 203 to: after the robotic body 401 has applied a coating material to the PV module 12, use the received thermal imaging data from the thermal imaging device 219, relating to one or more thermal characteristics at PV module 12, to evaluate a coating layer thickness, associated with the applied coating material, by comparing the received thermal imaging data to at least one predetermined threshold. When this received thermal imaging data falls outside of the at least one predetermined threshold, the controller 203 and/or thermal analysis module 195 can provide (e.g., output at a user interface display) a coating layer thickness defect indication. For instance, the coating layer thickness defect indication can correspond to a coating layer thickness that falls outside of a predetermined coating layer thickness range to be deposited at PV module 12. In this way, the coating layer thickness defect indication can help to identify and/or predict performance issues at the PV module associated with the coating layer thickness falling outside of the predetermined coating layer thickness range. In some applications, the coating material applied to a surface of the PV module 12 via the coating applicator 206 can include a hydrophobic and/or anti-static coating that is configured to reduce particulate accumulation at the photovoltaic module 12.

For example, the controller 203 can cause one or more coating materials to be conveyed from the reservoir 202 to coating applicator 206 such that the robotic body 401 is configured to apply the one or more coating materials, via the coating applicator 206, to one or more photovoltaic modules or other solar tracker component(s). Thus, the robotic body 401, via the controller 203 and coating applicator 206, can be configured to deposit a hydrophobic coating onto one or more PV modules 12. For instance, the robotic body 401, via the controller 203 and coating applicator 206, can be configured to deposit a hydrophobic coating over photovoltaic cells at one or more PV modules 12 such that the photovoltaic cells are overlaid by a hydrophobic coating layer. The robotic body 401 can do so as the robotic body 401 moves along the PV modules 12, for instance, via the robotic body 401 traversing along a given row of a solar tracker to deposit such a coating at the PV modules along that given row. As a result of the applied coating, the PV modules of the row may be imparted with an enhanced ability to repel ambient airborne particulate from the surface of the PV modules to thereby reduce or prevent energy generation obstruction. The thermal imaging device 219 can then be used to acquire thermal data relating to the PV module to assess the applied coating layer at the PV module 12.

Depending on the application and desired maintenance tasks to be performed, the robotic body 401 can additionally include one or more brush assemblies 210 coupled to, and controllable by, the controller 203. Each of the one or more brush assemblies 210 can include brush member 241 that can be rotatably driven, about a rotational axis, in direction(s) 248, 249, and relative to the robotic body 401 to sweep, buff, polish, or perform other brush-related maintenance task at PV module 12. The one or more brush assemblies 210 can be configured to perform one or more maintenance operations at one or more PV modules, for instance, in coordination with the maintenance solution applicator 206 (e.g., in coordination with the coating applicator and/or the cleaning solution applicator). For example, the one or more brush assemblies 210 can be configured to contact a given PV module and to perform at least one maintenance task at the contacted surface of the PV module. Such maintenance tasks performed by the one or more brush assemblies 210 can vary depending on the application of the maintenance solution applicator 206.

For example, when the robotic body 401 is configured to apply one or more coating materials, via the coating applicator 206, to the photovoltaic module as the robotic body moves along the photovoltaic module, the one or more brush assemblies 210 can perform a cleaning function and/or a coating finishing function. For example, when the robotic body 401 moves in direction 189 along a tracker row such that at least one brush assembly 210 is disposed at the robotic body 401 to lead the coating applicator 206, the at least one brush assembly 210 leading the coating applicator 206 can first perform a sweeping function to remove particulate at a given surface area of a given PV module followed by the coating applicator 206 then depositing one or more coating materials at the same given area of the given PV module after it has been swept. And, before, during, and/or after sweeping and/or coating material deposition at a given PV module, the thermal imaging device 219 can acquire thermal data relating to that given PV module. This order of maintenance operations can be useful in improving the adherence of the coating material at the swept PV module surface. As another example, when the robotic body 401 moves in direction 190 along a tracker row such that the coating applicator 206 is disposed at the robotic body 401 to lead the at least one brush assembly 210, the at least one brush assembly 210 trailing the coating applicator 206 can perform a coating finishing function at the deposited coating material after the coating applicator 206 has deposited the coating material at a given surface area of a PV module. As a yet further example, where the robotic body 401 includes a first brush assembly and second, different brush assembly, first brush assembly can be disposed to lead the coating applicator 206 and thus first brush assembly can perform the leading sweeping function ahead of the coating applicator 206 while the second brush assembly can be disposed to trail the coating applicator 206 and thus the second brush assembly can perform the trailing coating finishing function behind the coating applicator 206.

As noted, in some embodiments, the maintenance solution applicator 206 can include a cleaning solution applicator in addition, or alternative, to the coating applicator. Thus, in such embodiments, the robotic body 401 can perform maintenance tasks at PV modules including coating applications and fluid cleaning solution applications. Fluid cleaning solution applications can include output of one or more fluid cleaning solutions (e.g., pressurized air and/or liquid detergent solution, such as atomized liquid detergent solution) at a PV module or other solar tracker component. The illustrated embodiment of the PV robotic cleaning system 200 shows that a cleaning solution applicator 206 carried at robotic body 401, in addition to or alternative to a coating applicator. The illustrated embodiment of the PV robotic cleaning system 200 shows the reservoir 202 (e.g., cleaning solution and/or coating material reservoir 202) as offboard the robotic body 401 and in fluid communication with the cleaning solution applicator 206. For instance, the offboard cleaning solution reservoir 202 can be disposed at mobile cart 230 (e.g., the same mobile cart 230 as the coating reservoir) that accompanies the robotic body 401 and can be in fluid communication with the cleaning solution applicator at the robotic body 401. Though other embodiments within the scope of the present disclosure can have some, or all, of the maintenance solution reservoir 202 can be carried onboard at the robotic body 401. For instance, the reservoir 202 could be one or more replaceable bottles carried at the robotic body 401. Thus, the robotic body 401 can carry the reservoir 202 onboard and/or offboard the robotic body 401.

As also shown at the embodiment of FIG. 4A, the robotic body 401 can further include one or more valves 212 in fluid communication between the maintenance solution applicator 206 and the one or more reservoirs 202. The one or more valves 212 can be coupled to, and controllable by, the controller 203. For example, each of the one or more valves 212 can be controllable by the controller 203 to alter a fluid pressure and a fluid velocity of the coating material and/or fluid cleaning solution output from the applicator 206. This could include the controller 203 altering a fluid pressure and a fluid velocity of the coating material and/or fluid cleaning solution output from the applicator 206 as a function of one or more measurable operating characteristics detected by one or more sensor(s) 213 at robotic body 401. For example, the controller 203 can be configured to alter the fluid pressure and a fluid velocity output from the applicator 206 as a function of the speed at which the controller 203 moves the robotic body 401 along one or more PV modules (e.g., along row 120d). Some embodiments can additionally include at the robotic body 401 one or more flow meters coupled to the controller 203 and in fluid communication with the applicator 206.

As one exemplary such application, the controller 203 can be configured to adjust an output flow rate of a maintenance solution (e.g., coating material and/or fluid cleaning solution) from the applicator 206 when detected wind speed ambient to the vehicle body 401 exceeds a predetermined wind speed threshold. This can help to optimize adherence of the maintenance solution and/or reduce waste associated with output solution that may migrate off target as a result of the ambient wind force. Other additional or alternative examples can include the robotic body 401 having one or more light sensors, one or more flowmeters (e.g., associated with the applicator 206), and/or one or more temperature sensors (e.g., associated with the reservoir 202). For instance, as one exemplary application, when the temperature associated with the reservoir 202 is below a predetermined temperature threshold, the controller 203 can be configured to adjust (e.g., reduce, such as terminate) an output of the solution from the reservoir 202.

The embodiments of the PV robotic cleaning system 200 described herein can, for instance, be configured as an autonomous or semi-autonomous system 200 that is configured to autonomously, or semi-autonomously, acquire thermal data relating to PV modules 12 (e.g., and to perform one or more maintenance tasks at PV modules 12). For example, the system 200 can be configured to execute self-driven movement of the robotic body 201 or 401 along PV modules 12 at a tacker row 120d while autonomously executing one or more thermal data acquisition and/or maintenance tasks at such PV modules 12. The schematic diagrams of embodiments of the system 200 at FIGS. 3A-4B can thus form a closed-loop feedback and control system 200 operable to autonomously execute one or more maintenance tasks while the robotic body 201, 401 moves relative to the PV modules 12.

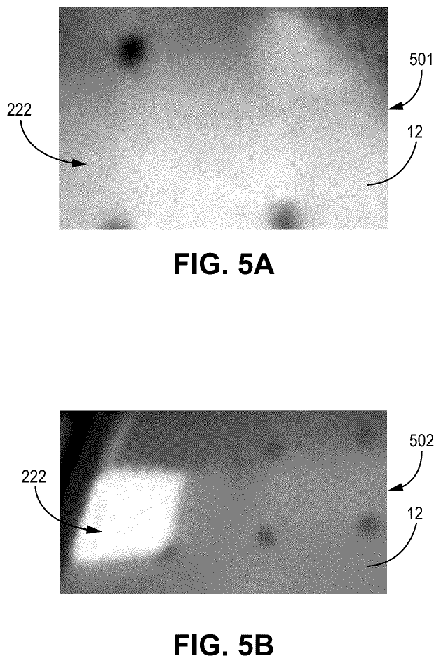

FIGS. 5A and 5B illustrate exemplary representations of composite thermal imaging data maps 501, 502, respectively, of a surface of a PV module at different times.

As noted, the thermal imaging device carried at the robotic body can be configured to capture thermal imaging data, for instance, relating to a thermal characteristic at the PV module. In some additional examples, the thermal imaging device carried at the robotic body can further be configured to capture visible light image data, for instance, of the PV module. In this way, the thermal imaging device carried at the robotic body can acquire both thermal imaging data and visible light imaging data relating to the same PV module. The thermal analysis module 195 can be configured to use both the thermal imaging data and the visible light imaging data relating to the same PV module to determine one or more PV module defects. For example, the thermal analysis module 195 can be configured to use both the thermal imaging data and the visible light imaging data relating to the same PV module to determine a presence of a mechanical defect at the PV module (e.g., structural anomaly at the surface of the PV module, such as a scratch, crack, or peeling/delaminating substrate at the surface of the PV module). This can include outputting an indication as to the presence of a mechanical defect at the PV module when both the acquired thermal imaging data meets at least one predetermined thermal threshold and the acquired visible light data meets at least one predetermined visible light threshold.

The first thermal imaging data represented by the composite thermal imaging data map 501 can be captured by the thermal imaging device at the robotic body when the robotic body traverses over the PV module 12 at a first time. In addition to the first thermal data corresponding to the PV module 12 at a first time, the controller can cause the programable processor to: receive, from the thermal imaging device at the robotic body, second thermal imaging data related to the same PV module 12 when the robotic body traverses over the photovoltaic module at a second, different time. This second thermal imaging data acquired at the same PV module 12 at a different time is represented at FIG. 5B by the composite thermal imaging data map 502. The thermal analysis module 195 can be configured to use this captured thermal data relating to a common PV module at different times to assess for the presence of potential PV module defects—including present defects at the PV module 12 and/or predicted future defects at the PV module 12.

For example, thermal analysis module 195 can be configured to compare the received second thermal imaging data to at least the first thermal imaging data, and, when the received second thermal imaging data differs from the first thermal imaging data, provide the photovoltaic module defect indication. As one such example, the thermal analysis module 195 can output a prediction as to future photovoltaic module failure when the received second thermal imaging data differs from the first thermal imaging data beyond a predetermined extent (e.g., and this divergence of data occurs within a predetermined time period). For instance, the first thermal imaging data at the first time—represented by the composite thermal imaging data map 501 at FIG. 5A—can include thermal imaging data relating to the PV module within a first thermal range at region 222 at PV module 12. And, the second thermal imaging data at the second, different time—represented by the composite thermal imaging data map 502 at FIG. 5B—can include thermal imaging data relating to the PV module within a second, different thermal range at region 222 at PV module 12. When the thermal data relating to the region 222 at PV module 12 at different times changes beyond a predetermined threshold (e.g., a predetermined magnitude of change in the thermal data acquired at different times at the region 222), the thermal analysis module 195 can be configured to provide one or more PV module 12 defect indications.

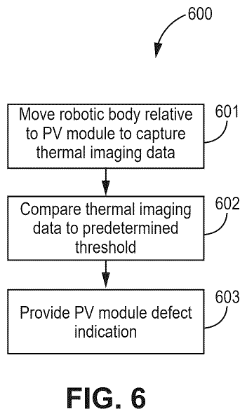

FIG. 6 is a flow diagram of an embodiment of method 600 of thermally inspecting a PV module. In some examples, the method 600 can be executed, at least in part, using any one of the features disclosed elsewhere herein. For instance, the method 600 could be executed by embodiments of the robotic thermal inspection system disclosed elsewhere herein.

At step 601, the method 700 includes moving a robotic body, along a photovoltaic module, to capture thermal imaging data relating to the photovoltaic module using a thermal imaging device at the robotic body.

At step 602, the method 700 includes comparing the captured thermal imaging data to at least one predetermined thermal threshold.

And, at step 603, the method 700 includes, when the captured thermal imaging data meets the at least one predetermined thermal threshold, providing a photovoltaic module defect indication.

Further embodiments of the method 600 can include one or more additional steps.

As one example, the method 600 can include the steps of: determining at least one of: (i) solar light irradiance at the photovoltaic module exceeding a predetermined irradiance threshold, and (ii) wind speed at the robotic body exceeding a predetermined wind threshold; when the solar light irradiance at the photovoltaic module is determined to exceed the predetermined irradiance threshold, adjusting an orientation of the thermal imaging device, relative to the robotic body, to reduce solar light irradiance captured by the thermal imaging device; and when wind speed at the robotic body is determined to exceed the predetermined wind threshold, terminating thermal imaging at the thermal imaging device.

As another additional or alternative example, the method 600 can include the steps of: sweeping a surface of the photovoltaic module using a brush assembly at the robotic body while moving the robotic body along the photovoltaic module; and after sweeping the surface of the photovoltaic module using the brush assembly, capturing the thermal imaging data relating to the photovoltaic module using the thermal imaging device.

As another additional or alternative example, the method 600 can include the step of: attaching the robotic body to the photovoltaic module such that one or more wheels at the robotic body contact the photovoltaic module. This could include using one or more features of the attachment mechanism at the robotic body as disclosed elsewhere herein.

Additional further embodiments of the method 600 can include one or more steps relating to application of a maintenance solution, such as disclosed elsewhere herein.

Various non-limiting exemplary embodiments have been described. It will be appreciated that suitable alternatives are possible without departing from the scope of the examples described herein.

What is claimed is:

1. A robotic thermal inspection system comprising:
a robotic body comprising: a controller, a motive source coupled to the controller, a thermal imaging device coupled to the controller, and an attachment mechanism for attaching the robotic body to a photovoltaic module; and
a thermal analysis module in communication with the thermal imaging device, the thermal analysis module comprising: a programmable processor and a non-transitory computer-readable medium storing instructions that, when executed by the programmable processor, cause the programmable processor to:
receive, from the thermal imaging device, thermal imaging data related to the photovoltaic module,
compare the received thermal imaging data to at least one predetermined thermal threshold, and
when the received thermal imaging data meets the at least one predetermined thermal threshold, provide a photovoltaic module defect indication.

2. The system of claim 1, wherein the thermal analysis module is at a server remote from the robotic body, and wherein the thermal imaging device is in wireless data communication with the thermal analysis module.

3. The system of claim 1, wherein the thermal analysis module is onboard the robotic body.

4. The system of claim 1, wherein, when executed by the programmable processor, the instructions further cause the programmable processor to: calibrate the thermal imaging device based on at least one environmental condition ambient to the thermal imaging device.

5. The system of claim 4, wherein, when executed by the programmable processor, the instructions further cause the programmable processor to:
determine a presence of solar light irradiance at the photovoltaic module exceeding a predetermined irradiance threshold, and
when the presence of solar light irradiance at the photovoltaic module is determined to exceed a solar light irradiance threshold, adjust an orientation of the thermal imaging device, relative to the robotic body, to reduce solar light irradiance captured by the thermal imaging device.

6. The system of claim 4, wherein, when executed by the programmable processor, the instructions further cause the programmable processor to:
determine a presence of wind at the robotic body exceeding a predetermined wind threshold, and
when the presence of wind at the robotic body is determined to exceed the predetermined wind threshold, terminate thermal imaging at the thermal imaging device.

7. The system of claim 1, wherein the robotic body further comprises a brush assembly coupled to the controller.

8. The system of claim 7, wherein the thermal imaging device is disposed at the robotic body to capture thermal imaging data at the photovoltaic module after the brush assembly has passed over the photovoltaic module.

9. The system of claim 7, wherein the robotic body further comprises a coating applicator coupled to the controller, and wherein the robotic body is configured to apply a coating material, via the coating applicator, to the photovoltaic module.

10. The system of claim 9, wherein, when executed by the programmable processor, the instructions further cause the programmable processor to:
after the robotic body has applied the coating material to the photovoltaic module, use the received thermal imaging data to evaluate a coating layer thickness, associated with the applied coating material, by comparing the received thermal imaging data to at least one predetermined threshold, and
when the received thermal imaging data falls outside of the at least one predetermined threshold, provide a coating layer thickness defect indication.

11. The system of claim 10, wherein the coating material comprises a hydrophobic coating that is configured to reduce particulate accumulation at the photovoltaic module.

12. The system of claim 1, wherein the photovoltaic module defect indication comprises an indication relating to at least one of: an electrical component failure at the photovoltaic module, a string disconnection at the photovoltaic module, and a mechanical defect at a surface of the photovoltaic module.

13. The system of claim 1,
wherein the thermal imaging data is first thermal imaging data captured by the thermal imaging device when the robotic body traverses over the photovoltaic module at a first time, and
wherein, when executed by the programmable processor, the instructions further cause the programmable processor to:
receive, from the thermal imaging device, second thermal imaging data related to the photovoltaic module when the robotic body traverses over the photovoltaic module at a second, different time,
compare the received second thermal imaging data to at least the first thermal imaging data, and
when the received second thermal imaging data differs from the first thermal imaging data, provide the photovoltaic module defect indication.

14. The system of 13, wherein, when executed by the programmable processor, the instructions further cause the programmable processor to: output a prediction as to future photovoltaic module failure when the received second thermal imaging data differs from the first thermal imaging data beyond a predetermined extent.

15. The system of claim 1, wherein the thermal imaging device comprises a first thermal imaging camera and a second thermal imaging camera spaced apart about the robotic body.

16. The system of claim 15,
wherein the first thermal imaging camera is disposed at the robotic body to capture first thermal imaging data at a first region along the photovoltaic module, and wherein the second thermal imaging camera is disposed at the robotic body to capture second thermal imaging data at a second, different region along the photovoltaic module, and
wherein the thermal analysis module is configured to combine the first thermal imaging data with the second thermal imaging data to form a composite thermal imaging data map of the first region along the photovoltaic module and the second region along the photovoltaic module.

17. A method of thermally inspecting a photovoltaic module, the method comprising the steps of:
moving a robotic body, along a photovoltaic module, to capture thermal imaging data relating to the photovoltaic module using a thermal imaging device at the robotic body;
comparing the captured thermal imaging data to at least one predetermined thermal threshold, and
when the captured thermal imaging data meets the at least one predetermined thermal threshold, providing a photovoltaic module defect indication.

18. The method of claim 17, further comprising the steps of:
determining at least one of: (i) solar light irradiance at the photovoltaic module exceeding a predetermined irradiance threshold, and (ii) wind speed at the robotic body exceeding a predetermined wind threshold;
when the solar light irradiance at the photovoltaic module is determined to exceed the predetermined irradiance threshold, adjusting an orientation of the thermal imaging device, relative to the robotic body, to reduce solar light irradiance captured by the thermal imaging device; and
when wind speed at the robotic body is determined to exceed the predetermined wind threshold, terminating thermal imaging at the thermal imaging device.

19. The method of claim 17, further comprising the steps of:
sweeping a surface of the photovoltaic module using a brush assembly at the robotic body while moving the robotic body along the photovoltaic module; and
after sweeping the surface of the photovoltaic module using the brush assembly, capturing the thermal imaging data relating to the photovoltaic module using the thermal imaging device.

20. The method of claim 17, further comprising:
attaching the robotic body to the photovoltaic module such that one or more wheels at the robotic body contact the photovoltaic module.
